(19) United States
(12) Patent Application Publication
(10) Pub. No.: US 2022/0347860 A1
(43) Pub. Date: Nov. 3, 2022

(54) Social Interaction Robot

(71) Applicant: Huawei Technologies Co., Ltd., Shenzhen (CN)

(72) Inventors: Crystal Chao, Addison, TX (US); Kristopher Li, Addison, TX (US)

(21) Appl. No.: 17/866,127

(22) Filed: Jul. 15, 2022

Related U.S. Application Data
(63) Continuation of application No. PCT/US2020/014026, filed on Jan. 17, 2020.

(51) Int. Cl. B25J 11/00; B25J 9/16

(52) U.S. Cl. CPC B25J 11/0015; B25J 9/1694

(57) ABSTRACT

An interactive robot having mechanical torso, limbs, and head assembled for movement with multiple degrees of freedom to enable life-like movements and responses. The robot's head may further include LED displays as the eyes and mouth, and a speaker associated with the mouth. These features enable life-like audio and visual responses, including complex facial expressions and conversational audio interaction.

### CROSS-REFERENCE TO RELATED APPLICATIONS

This patent application is a continuation of International Application No. PCT/US2020/014026 filed on Jan. 17, 2020, by Futurewei Technologies, Inc., and titled “A Social Interaction Robot,” which is hereby incorporated by reference.

### TECHNICAL FIELD

The disclosure generally relates to robots, and in particular to a socially-interactive robot having movable arms and head, environmental sensors, an artificial intelligence (AI) processor and a graphical facial display, together providing interactive responses and social companionship to children or others.

### BACKGROUND

Robotic toys are known for use by children. Such toys have movable limbs, but are generally limited in their ability to interact with children for a number of reasons. For example, robotic toys have limited or no ability to perceive their environment. Some toys are known which have touch sensors in the hands, feet or elsewhere to provide recorded responses when pressed. Other than being initiated by touch, these predefined responses are not based on what is going on around the robotic toy. Additionally, robotic toys have fixed facial features, or features with highly limited ability to move. Thus, current robotic toys have little or no ability to display emotion appropriately responsive to a child or the environment around the robot.

### SUMMARY

In embodiments, there is provided an interactive robot having mechanical torso, limbs and head assembled for movement with multiple degrees of freedom to enable life-like movements and responses. The robot's head may further include light emitting diode (LED) displays as the eyes and mouth, and a speaker associated with the mouth. These features enable life-like audio and visual responses, including complex facial expressions and conversational audio interaction. The interactive robot is provided with multiple sensors including cameras, microphones and touch sensors for receiving multimodal input from a child or others in the robot's surroundings. The multimodal input may be interpreted by an artificial intelligence (AI) processor which controls the robot to provide an interactive response socially appropriate to the input. These responses may for example include movement of the robot's limbs, torso or head, interactive facial expression and conversational speech.

According to one aspect of the present technology, there is provided a robot configured for social interaction with one or more individuals, the robot comprising: a torso; arms configured for movement relative to the torso; a head configured for movement relative to the torso; one or more sensors configured to sense an environment around the robot; display screens in the head configured to display various images of eyes and mouth of the robot; a speaker; and a processor for executing software instructions to: receive feedback of the environment surrounding the robot from the one or more sensors; interpret the feedback of the environment; perform an action responsive to the interpreted feedback, the performed action comprising displaying the eyes and/or mouth on one or more of the display screens with an expression based on the interpretation of the feedback of the environment to emulate a human response to the feedback of the environment.

Optionally, in the preceding aspect, the performed action comprises outputting an audio response over the speaker based on the interpretation of the feedback of the environment to emulate a human response to the feedback of the environment.

Optionally, in any of the preceding aspects, the performed action comprises performing a gesture with the arms based on the interpretation of the feedback of the environment to emulate a human response to the feedback of the environment.

Optionally, in any of the preceding aspects, the processor is further configured to position the head in a direction of the one or more individuals.

Optionally, in any of the preceding aspects, the step of outputting an audio response over the speaker based on the interpretation of the feedback of the environment comprises the step of having a conversation with the one or more individuals.

Optionally, in any of the preceding aspects, the processor is implemented using a neural network which improves an ability of the processor over time to interpret the feedback of the environment.

Optionally, in any of the preceding aspects, the one or more sensors detect an age group of an individual of the one or more individuals, the neural network interpreting the feedback in light of the detected age group.

Optionally, in any of the preceding aspects, the arms are configured to move with at least two degrees of freedom relative to the torso.

Optionally, in any of the preceding aspects, the head is configured to move with at least two degrees of freedom relative to the torso.

Optionally, in any of the preceding aspects, the robot further includes a base, wherein the torso is configured to rotate relative to the base.

Optionally, in any of the preceding aspects, the one or more sensors comprise a camera for capturing images of the environment surrounding the robot.

Optionally, in any of the preceding aspects, the one or more sensors comprise a microphone for capturing audio in the environment surrounding the robot.

Optionally, in any of the preceding aspects, the one or more sensors radio frequency identification (RFID) readers in the arms of the robot.

Optionally, in any of the preceding aspects, the one or more sensors comprise touch sensors for sensing physical contact with the robot.

Optionally, in any of the preceding aspects, the touch sensors comprise a conductive layer applied to a surface of the robot to enable sensing of physical contact over the entire surface.

According to further aspects of the present technology, there is provided a robot configured for social interaction, the robot comprising: a torso; arms configured for movement relative to the torso; a head configured for movement relative to the torso; one or more sensors configured to sense a child interacting with the robot; display screens in the head configured as eyes and mouth of the robot; and a processor implementing a neural network executing software instructions to: receive feedback of the child's actions from the one or more sensors, interpret the feedback of the environment, formulate a response of the robot based on the child's actions as interpreted by the processor, and implement the response by positioning the arms, positioning the head, or displaying facial expression of the eyes and/or mouth on the display screens.

Optionally, the preceding aspect, the robot includes motors, controlled by the processor, for moving the arms and head.

Optionally, in any of the preceding aspects, the response from the robot is to display the eyes and/or mouth on one or more of the display screens with an appearance emulating a facial expression responsive to the child's actions.

Optionally, in any of the preceding aspects, the response from the robot is to move one or more of the head, arms and torso emulating a human response to the child's actions.

Optionally, in any of the preceding aspects, the robot further includes a speaker, wherein the response from the robot is to provide an audio response to the child's actions over the speakers.

According to further aspects of the present technology, there is provided a robot configured for social interaction, the robot comprising: a torso; arms configured for movement relative to the torso; a head configured for movement relative to the torso; one or more sensors configured to sense an environment around the robot; display screens in the head configured as eyes and mouth of the robot; and a processor implementing a neural network, the processor configured to: receive feedback of the environment surrounding the robot from the one or more sensors, the feedback including detecting an age group of an individual around the robot, determine a response of the robot to the feedback based on training of the neural network and a detected age group of the individual, providing the determined response, comprising rendering eyes and/or mouth on one or more of the display screens, and positioning the torso, arms and/or head, to facilitate the social interaction of the robot.

Optionally, in the preceding aspect, the one or more sensors comprise one or more of a camera, a microphone and a tactile sensor.

Optionally, in any of the preceding aspects, positioning the torso, arms and/or head comprises moving the torso and head of the robot to face the individual.

Optionally, in any of the preceding aspects, rendering the eyes includes rendering pupils in the eyes to look at the individual.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 is a perspective view of a robot according to embodiments of the present technology.

FIG. 2 is a front view of a robot according to embodiments of the present technology.

FIG. 3 is a rear view of a robot according to embodiments of the present technology.

FIG. 4 is a first side view of a robot according to embodiments of the present technology.

FIG. 5 is a second side view of a robot according to embodiments of the present technology.

FIG. 6 is a perspective view of an interior of a robot according to embodiments of the present technology.

FIG. 7 is a partial exploded perspective view of the robot of FIG. 6 according to embodiments of the present technology.

FIGS. 8A-8H are illustrations of different facial expressions of a robot according to embodiments of the present technology.

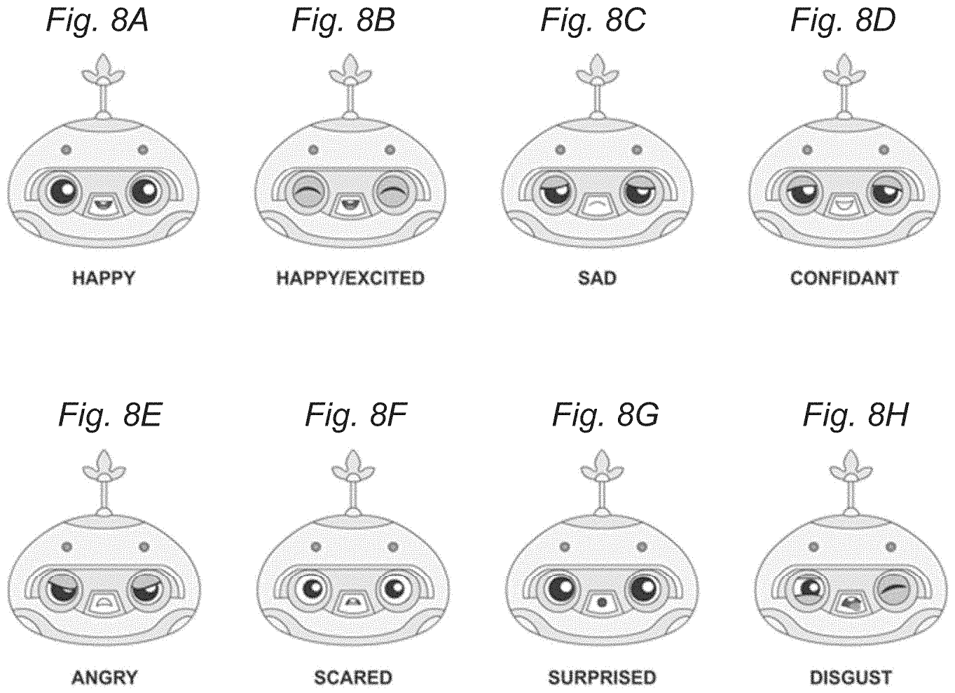

FIG. 9 is a front view of a finished robot according to embodiments of the present technology.

FIG. 10 is a rear view of a finished robot according to embodiments of the present technology.

FIG. 11 is a schematic block diagram of an exemplary computing environment for implementing aspects of the present technology.

### DETAILED DESCRIPTION

The present disclosure will now be described with reference to the figures, which in embodiments relate to an interactive robot for providing interactive responses and social companionship to children or others. It is understood that the present technology may be embodied in many different forms and should not be construed as being limited to the embodiments set forth herein. Rather, these embodiments are provided so that this disclosure will be thorough and complete and will fully convey the technology to those skilled in the art. Indeed, the technology is intended to cover alternatives, modifications and equivalents of these embodiments, which are included within the scope and spirit of the technology as defined by the appended claims. Furthermore, in the following detailed description of the present technology, numerous specific details are set forth in order to provide a thorough understanding of the present technology. However, it will be clear to those of ordinary skill in the art that the present technology may be practiced without such specific details.

The terms “top” and “bottom,” “upper” and “lower” and “vertical” and “horizontal” as may be used herein are by way of example and illustrative purposes only, and are not meant to limit the description of the technology inasmuch as the referenced item can be exchanged in position and orientation. Also, as used herein, the terms “substantially,” “approximately” and/or “about” mean that the specified dimension or parameter may be varied within an acceptable manufacturing tolerance for a given application. In one embodiment, the acceptable manufacturing tolerance is ±2.5% of a given dimension.

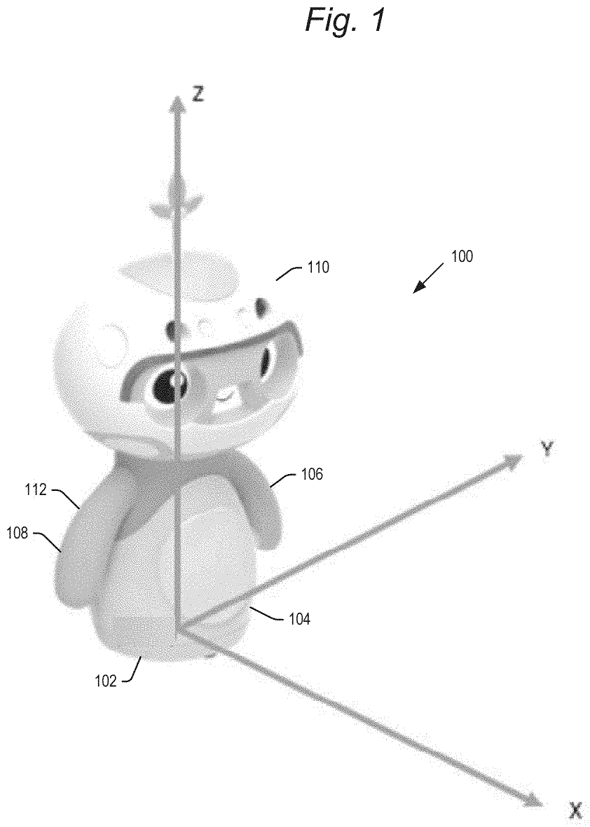

Referring now to FIG. 1, there is shown a perspective view of a completed robot 100 in accordance with the present technology, including a base 102, torso 104, arms 106 and 108, and head 110. In embodiments, the torso, arms and head of robot 100 are anthropomorphic, though they need not be in further embodiments. The robot 100 is shown in Cartesian space including axes X, Y and Z. For example, the torso 104 is configured to pan (i.e., rotate about the z-axis) with one degree of freedom relative to the base 102. The arms 106, 108 may each be configured to tilt and/or roll (i.e., rotate about the y-axis and/or x axis, respectively) with two degrees of freedom relative to the torso 104. And the head 110 is configured to pan and/or tilt (i.e., rotate about the z-axis and/or y axis, respectively) with two degrees of freedom relative to the torso 104. The pan, tilt and roll of the various movable components of robot 100 are explained in greater detail below.

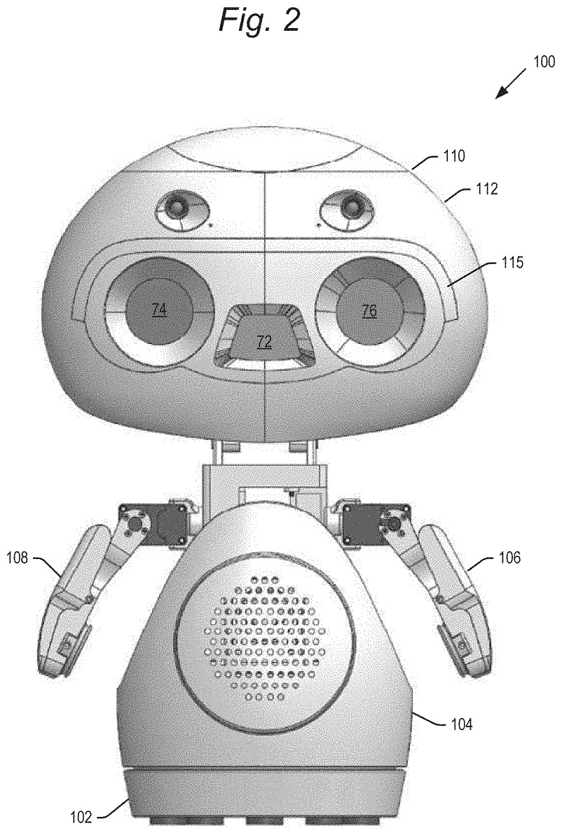

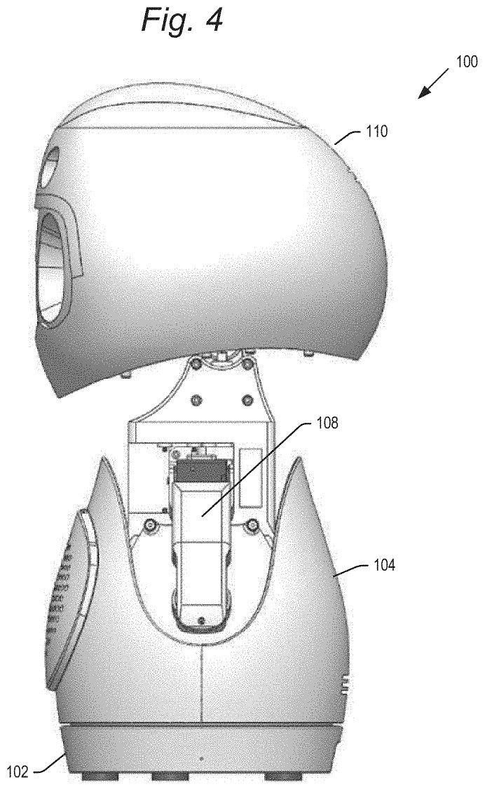

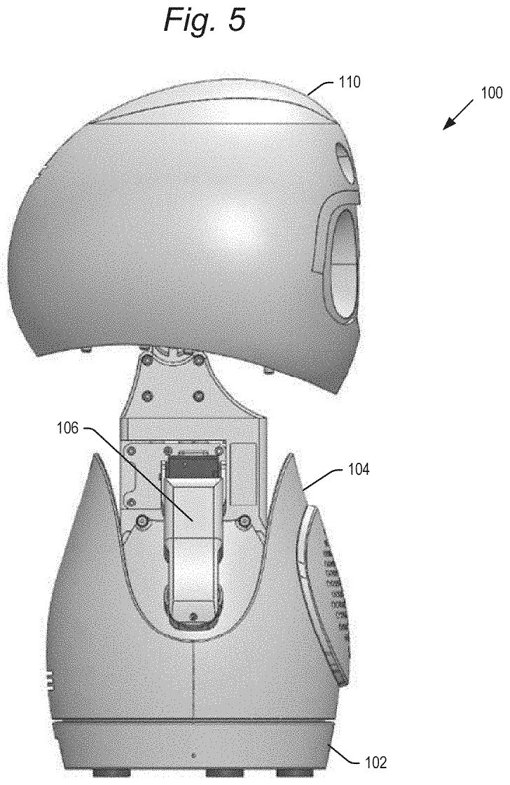

FIGS. 2-5 show front, rear, left-facing and right-facing views of robot 100 respectively. In FIGS. 2-5, an outer layer 112 of robot 100 (shown in FIG. 1) is omitted. The base 102, torso 104, arms 108 and head 110 shown in FIGS. 2-4 (beneath the outer layer 112 in FIG. 1) may be formed of a polycarbonate or a variety of other high strength, light weight plastics, metals or other materials. The outer layer may be formed of hard materials such as plastic and soft materials such as fabric or plush as explained below.

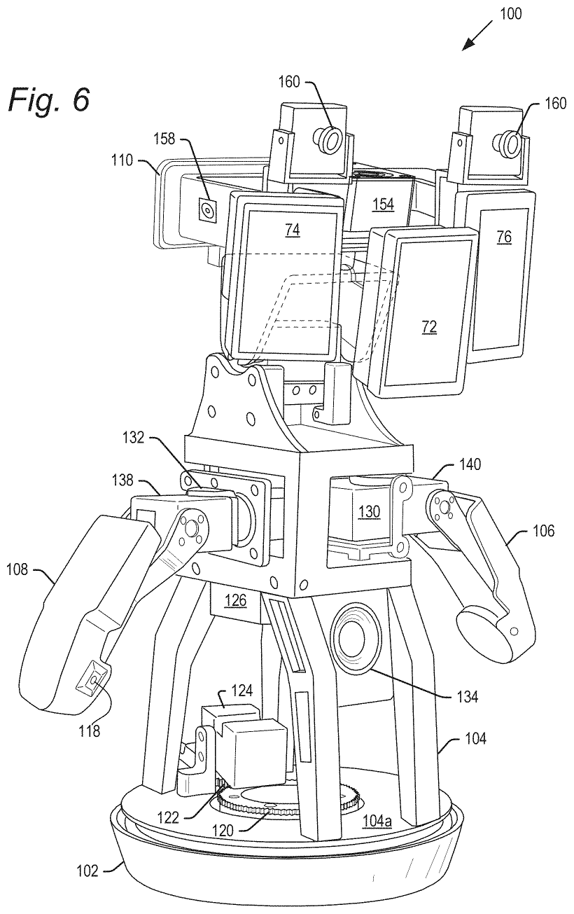

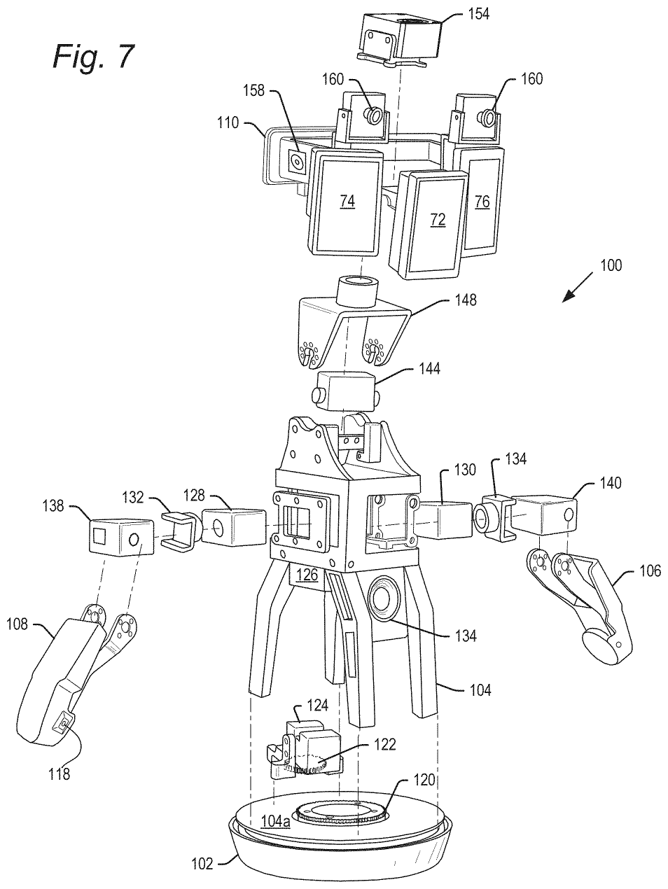

As seen in FIGS. 2-5, the torso 104 may extend relatively seamlessly from the base 102. The torso 104 may be rotationally mounted to the base 102 for panning about the Z axis. Referring now to the interior view and exploded interior view of FIGS. 6 and 7, respectively, in one example, the torso 104 may be fixedly mounted to a torso base 104a, which is in turn supported on base 102 on bearings allowing rotation of the torso base and torso with respect to the base 102. A pinion ring 120 may be fixedly mounted in the base 102 and may extend up through a central opening in torso base 104a. The pinion ring 120 may be engaged by a rack gear 122 fixedly mounted on the torso base 104a and driven by a bi-directional motor 124. Upon receiving a control voltage from a controller (explained below), the motor 124 rotates the rack gear 122, causing panning of the torso 104 relative to the base 102 in a clockwise or counterclockwise direction. The torso 104 may be rotationally mounted to the base 102 by other drive mechanisms in further embodiments.

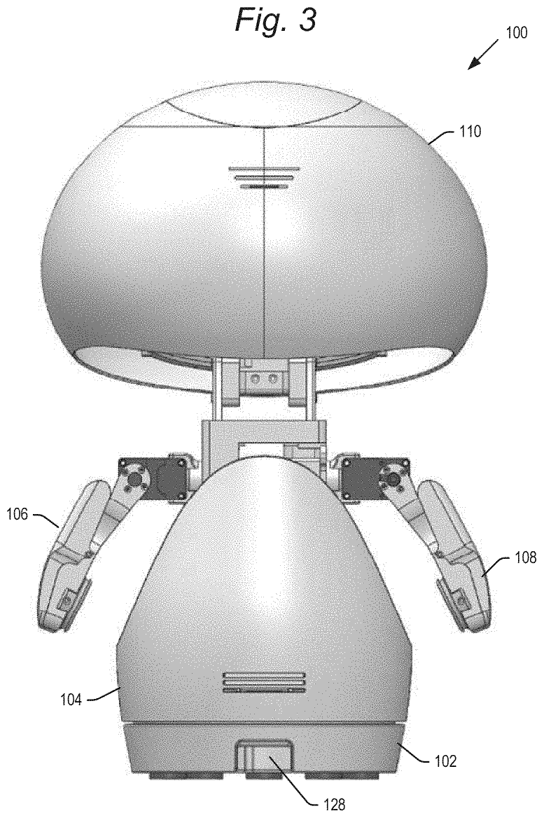

The torso 104 may be controlled to rotate through +/−360°, though the rotational range of the torso 104. In further embodiments, the rotational range of the torso may be less than that, such as for example panning to the left 120° and panning right 120° relative to a neutral position where the robot 100 is facing forward. Other panning ranges are contemplated. As explained below, the torso may be controlled to pan so as to face one or more children, or other individuals, as they interact with or move around the robot 100. The base 102 may include weights to add stability to the robot 100 as it pans, tilts and rolls. The base 102 may further include a rechargeable battery, with a charging port 128 (FIG. 3), for powering the robot 100.

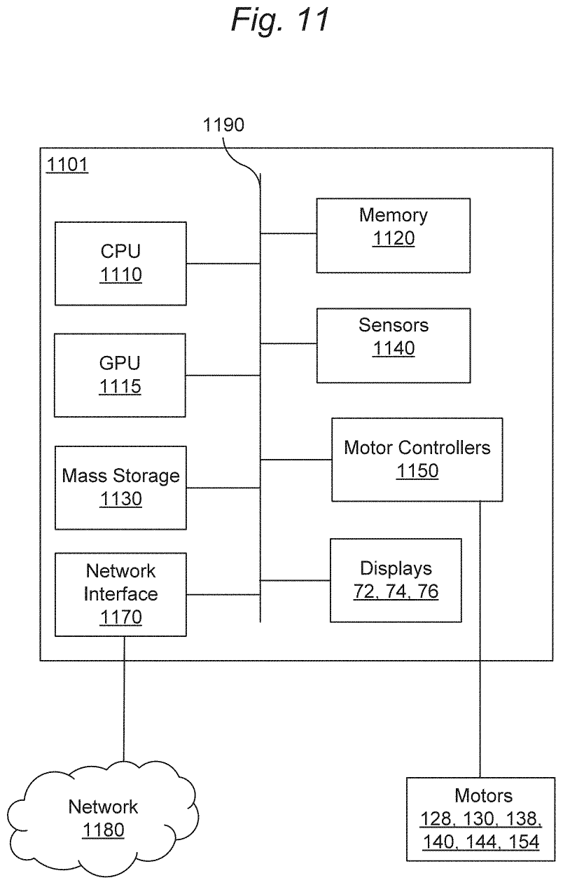

A computing device 126 may be mounted in the torso 104, though it may be mounted in the head or elsewhere in robot 100 in further embodiments. Details of the computing device 126 are explained below with reference to FIG. 11, but in general, the computing device 126 may include a processor configured to control the operations of robot 100, and a memory for storing algorithms and data used by the processor. The computing device 126 may further include communications circuitry such as a network interface for connecting the robot to various cloud resources via the Internet.

Referring again to FIGS. 6 and 7, robot 100 may include various output devices, including speaker 134 mounted within torso 104. The speaker 134 may be mounted elsewhere, such as for example in head 110, in further embodiments. The computing device 126 may synthesize speech, using for example a text-to-speech (TTS) algorithm executed by the computing device 126. The synthesized speech may then be output from speaker 134. The speaker 134 may also be used to output sound effects and music.

The torso may further include a number of motors for actuating the tilt and roll of the arms 106, 108, and pan and tilt of the head 110. In particular, bi-directional arm tilt motors 128 and 130 may be mounted in the torso 104 having output shafts affixed to a pair of shoulder joints 132, 134 on opposite sides of the torso 104 (shown for example in FIG. 7). Thus, rotation of the arm tilt motors 128, 130 may tilt the shoulder joints 132, 134 either clockwise or counterclockwise about the Y axis. The arm tilt motors 128, 130 may be controlled independently or together for movement of one or both of arms 106, 108.

In one embodiment, the motors 128, 130 may rotate the shoulder joints 132, 134 and arms 106, 108 forward (out in front of the robot 100) through a range of 200°, starting from a neutral position where the arms are pointing downward. In one embodiment, the motors 128, 130 may also rotate the shoulder joints and arms backward (behind the robot) through a range of 120°, again, starting from the neutral position. It is understood that the arm tilt motors 128, 130 may rotate the arms forward and/or backward through smaller or larger ranges in further embodiments.

The arms 106, 108 may be rotationally mounted on the shoulder joints 132, 134 so as to roll about the X axis relative to the shoulder joints toward and away from the torso 104. In particular, bi-directional arm roll motors 138 and 140 be mounted in the shoulder joints 132, 134 having output shafts affixed to respective arms 106 and 108. Thus, rotation of the arm roll motors 138, 140 may roll the arms 106, 108 either clockwise or counterclockwise about the X axis. The arm roll motors 138, 140 may be controlled independently or together for movement of one or both of arms 106, 108.

In one embodiment, the motors 138, 140 may rotate the arms outward (away from the torso 104) through a range of 34°, starting from a neutral position where the arms are pointing downward. In one embodiment, the motors 138, 140 may also rotate the arms inward (toward the torso 104) through a range of 15°, again, starting from the neutral position. It is understood that the arm roll motors 138, 140 may rotate the arms inward or outward through smaller or larger ranges in further embodiments.

Using the arm tilt and roll motors 128, 130, 138 and 140, the computing device may control the arms 106, 108 to move with two degrees of freedom into a variety of positions. As explained below, these positions may be used to perform some expressive gesturing or pointing motions in response to feedback from the environment around the robot 100.

The head 110 may be mounted to tilt up and down relative to the torso 104. In particular, the robot 100 may further include bi-directional head tilt motor 144 (FIG. 7) mounted in the torso 104 having a pair of output shafts affixed to a bracket 148 forming a neck joint at a top of the torso 104. Rotation of the head tilt motor 144 may tilt the neck joint 148 either clockwise or counterclockwise about the Y axis. In one embodiment, the head tilt motor 144 may rotate the neck joint upward (i.e., the head 110 tilts upward) through a range of 30° or 45° from a neutral position where the head 110 is positioned horizontally (not facing upward or downward). In one embodiment, the head tilt motor 144 may rotate the neck joint downward (i.e., the head 110 tilts downward) through a range of 10° or 30° from the neutral position where the head 110 is positioned horizontally. It is understood that the head tilt motor 144 may rotate the neck joint 148 up and/or down through smaller or larger ranges in further embodiments.

The head 110 may also be mounted to pan left and right relative to the torso 104 and neck joint 148. In particular, the robot 100 may further include bi-directional head pan motor 154 mounted on top of the neck joint 148 having an output shaft to which the head 110 is attached. Rotation of the head pan motor 154 may pan the head 110 either clockwise or counterclockwise about the Z axis. In one embodiment, the head pan motor 154 may rotate the neck joint left through a range of 120° from a neutral position where the head 110 is facing straight forward. In one embodiment, the head pan motor 154 may rotate the neck joint right through a range of 120° from a neutral position where the head 110 is facing straight forward. It is understood that the head pan motor 154 may rotate the head 110 left and/or right through smaller or larger ranges in further embodiments.

Using the head tilt and pan motors 144, 154, the computing device may control the head 110 to move with two degrees of freedom up/down or left/right into a variety of positions. As explained below, these positions may be used to gather sensor data from different locations of the robot's environment. These positions may also emulate the robot making eye contact with individuals and/or paying attention to different locations around the robot's environment.

In the embodiment described above, the head tilt motor 144 is affixed between the torso 104 and neck joint 148, and the head pan motor 154 is affixed between the neck joint 148 and head 110. In a further embodiment, the head pan motor 154 may be affixed between the torso 104 and neck joint 148, and the head tilt motor 144 may be affixed between the neck joint 148 and head 110.

Moreover, in the embodiments described above, the shoulder joints 132, 134, arms 106, 108, neck joint 148 and head 110 were all described as being directly connected to the output shafts of the respective pan, tilt and roll motors. However, in further embodiments, the shoulder joints 132, 134, arms 106, 108, neck joint 148 and/or head 110 may be spaced away from their respective pan, tilt and/or roll motors. In such embodiments, force transmission linkages, including for example gears, pinions, sprockets, racks, chains and/or pulleys, may be used to communicate the torque from one or more of the motors to their driven component.

Robot 100 may include various sensors for sensing the environment around the robot. These sensors may include one or more microphones 158 mounted in the head 110 (one such microphone is shown in FIGS. 6 and 7). The one or more microphones 158 may be mounted elsewhere in further embodiments. The microphone(s) 158 may be used to receive audio signals from the environment around the robot. The audio signals may be processed to detect speech, for example by automatic speech recognition (ASR) software running within the computing device 126. In embodiments, there may be two forward-facing microphones 158 (with respect to a front of robot shown for example in FIG. 2) above eyes of the robot 110, which are directed towards users to capture audio data that improves performance of the ASR software. A number of additional microphones 158, for example four, may be placed towards the top and or rear of the head 110, and oriented upwards and/or backwards. Using the microphones 158 facing to the sides, forwards, upwards and/or backwards, the computing device may be able to interpret a direction of arrival (DOA) of sound sources.

In addition to the one or more microphones 158, robot 100 may also include one or more cameras 160, mounted in the head 110, though camera(s) 160 may be mounted elsewhere in further embodiments. In embodiments, the robot 100 may include two forward-facing RGB stereo cameras. The cameras 160 may be used to capture image data for computer vision algorithms implemented by the computing device 126, including but not limited to face recognition and tracking, emotion recognition, body pose estimation, gesture recognition, and object recognition. The RGB cameras may also use stereo disparity algorithms to identify the distances between the robot 100 and objects captured by the cameras. In further embodiments, one or more depth cameras may be used.

In accordance with aspects of the present technology, the head 110 may include a face design having three independent display screens 72, 74 and 76, used for the left eye, right eye and mouth of the robot, respectively. In embodiments, the display screens 72, 74 and 76 may be rectangular, but they may be circular, oblong, oval or other shapes in further embodiments. The shapes and sizes of screens 72, 74 and 76 may vary based for example on what will fit inside the head 110. In embodiments, the size and/or shape of the display screen 72 used for the mouth may be different than the size and/or shape of the display screens 74 and 76 used for the eyes. The positions and orientations of the display screens 72, 74 and 76 on the head 110 is also flexible and may vary in different embodiments.

As seen for example in FIG. 2, the outer layer 112 of the head 110 is provided with holes in the general shape of eyes and a mouth. Portions of the display screens 72, 74 and 76 are visible within these holes so that, when images of eyes and mouth are rendered on screens 72, 74 and 76, they are displayed on the portions of the screens 72, 74 and 76 visible through the holes in the outer layer.

Humans have certain uniform facial expressions when experiencing certain emotions. These facial expressions, and in particular the positions of the mouth and eyes, have been mapped to different emotional states. Using this known mapping, the computing device 126 is able to display images of the mouth and eyes of robot 100 on display screens 72, 74 and 76 so as to give the robot 100 the appearance of experiencing different human emotional states.

For example, it is known that humans generally express happiness with a facial expression including an upturned mouth and eyes wide open. Accordingly, the display screens 72, 74 and 76 may display images of an upturned mouth and eyes wide open when the computing device 126 determines the robot 100 is to express happiness (perhaps empathizing with someone in the robot's environment). It is known further that humans generally express anger with a facial expression including a downturned mouth and eyes having a furrowed brow. Accordingly, the display screens 72, 74 and 76 may display images of a downturned mouth and eyes with a furrowed brow when the computing device 126 determines the robot 100 is to express anger (again, perhaps empathizing with someone in the robot's environment).

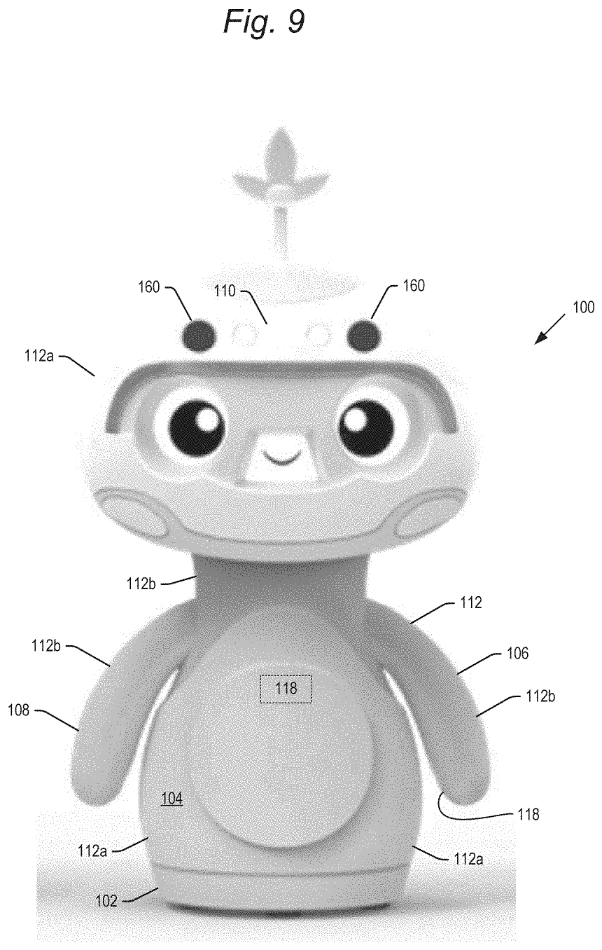

FIGS. 9A-9H illustrate various images which may be shown on the display screens 72, 74 and 76 to indicate different emotions the robot is emulating. FIGS. 9A-9D show examples of mouth and eye images displayed on screens 72, 74 and 76 emulating that the robot 100 is happy, excited, sad or confident, respectively. FIGS. 9E-9H show examples of mouth and eye images displayed on screens 72, 74 and 76 emulating that the robot 100 is angry, scared, surprised or disgusted, respectively. These images and expressions are by way of example only, and other images may be used to express other or different emotions. It is also understood that different cultures may have different facial features at the mouth and/or eyes to express different emotions. Robot 100 may be configured to express such emotions of different cultures.

Eye lids and/or eye brows may also be rendered on screen 74 and 76 to enhance the life-like expressiveness and communication of the rendered facial features. Eye pupils may also be rendered, centered in a direction of an individual in the environment of the robot 100, to enhance the impression that the robot is focused on and interacting with the individual.

As noted above, the one or more microphones 158 may pick up audio signals which may be interpreted as speech using ASR software in the computing system 130. The computing system 130 may recognize speech and determine an appropriate verbal response. This response is converted to speech using TTS software in the computing system 130, and output via the speaker 134. In addition to mapping certain positions of the mouth to emotional states, the position of the mouth has been mapped to certain visemes when making speaking certain sounds and words. It is a further feature of robot 100 that the display screen 72 may render graphics in the form of visemes that are synchronized in timing with the spoken audio output by the speaker 134.

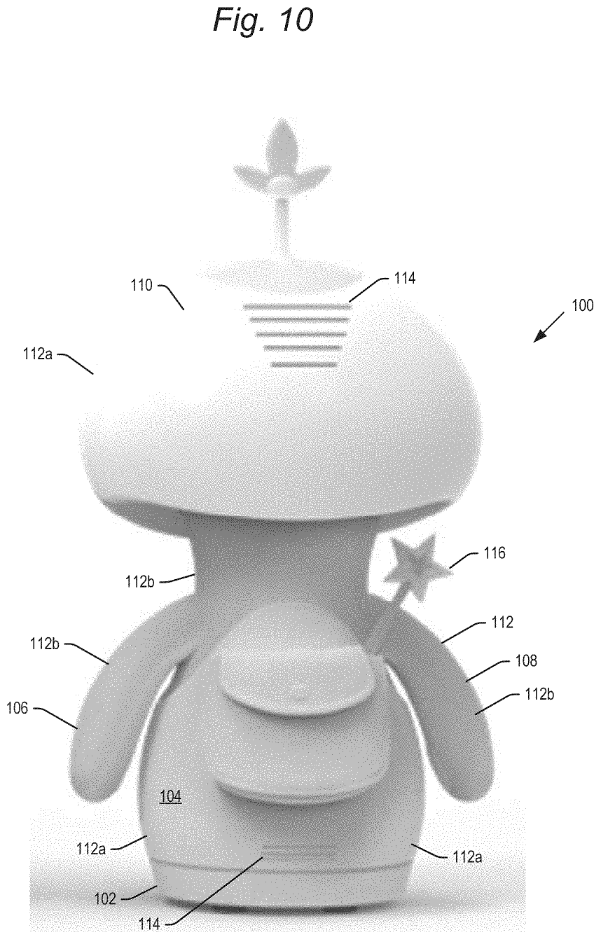

Referring now to FIGS. 1, 9 and 10, the outer layer 112 of the robot 100 incorporates a mixture of hard materials 112a and soft materials 112b. The hard materials 112a may for example be polycarbonate or other plastics or metals. The soft materials 112b may for example be fabric or plush. The hard and/or soft materials may be made of other materials in further embodiments. For example, the soft materials 112b may be or include silicone or foam filling, injection molded to the desired shapes or used as stuffing. In embodiments, hard materials 112a are used for the head and the lower half of the torso. Soft materials 112b cover the arms and the upper half of the torso. However, the overall shape, colors, finishes, and feel of the exterior of robot 100 may vary depending on aesthetic design choices. As such, the provision of hard and soft materials may vary in further embodiments, including a robot 100 having all hard materials in the outer layer 112, or all soft materials in the outer layer 112.

The hard materials 112a provide a sturdy frame to which the internal components may be affixed, (such as the computing device 126, the speaker 134, the cameras 160, the display screens 72, 74, 76, etc.). The soft materials are pliant, and makes the robot more appealing to young children. Similar to a plush doll, the design promotes long-term relational attachment and engagement. It also promotes touch-based interaction patterns. The soft materials 112b may be padded for additional softness. The hard materials 112a in the head and the body may contain cutout slits 114 for thermal ventilation. A wide variety of decretive accoutrement 116 may be provided on the exterior of robot 110, though such accoutrement may be omitted in further embodiments. In one example, the robot 100 may be 12 inches tall, but could be larger or smaller than that in further embodiments.

The robot 100 may incorporate capacitive touch sensing throughout the hard and/or soft layers 112a, 112b. For example, the hard and/or soft materials 112a, 112b may be coated partially or entirely with a conductive paint on an interior surface of the material. A contact pad may be affixed on the interior surface, and a lead may electrically connect the contact pad to the computing device 126 so that the computing device 126 can sense contact with a hard or soft layer 112a, 112b. The touch sensitive areas may be separated into discrete regions (e.g., the head, each arm, torso), each having a separate electrical connection to the computing device 126. In this way, the computing device can sense not only contact, but the area of contact. A wide variety of touch-sensitive materials may be used instead of conductive paint, including for example copper or other conductive tape along the full interiors of the hard and/or soft materials 112a, 112b. Conductive threads could be used in the soft materials 112b. Haptic sensors may be provided in the soft layers 112b in addition to or instead of a conductive paint.

In embodiments, radio-frequency identification (RFID) sensors 118 (FIGS. 6 and 7) may be incorporated into the robot 100, such as for example in the robot hands at the ends of each arm 106, 108, or on the torso 104. These can be used to recognize objects containing RFID tags by tapping them on the sensor. The RFID tags may be replaced with Near-Field Communication (NFC) or alternative types of near-field sensors in further embodiments.

A colored light-emitting diode (LED) strip 115 (FIG. 2) may be placed on a forehead of robot 100. The LED strip 115 may serve as a visual status indicator. Depending on the situation, the LED strip 115 may communicate various information such as turn-taking state, notifications, errors, a progress bar, or reward signals.

In accordance with the present technology, the computing device 126 may receive a wide variety of sensor data of the environment around the robot 100 from the microphone 158, cameras 160, the outer layer touch sensors, and/or RFID sensors. The computing device 126 may receive all sensor data, and determine an appropriate action in response to the sensor data. These responses may include any of a wide variety of responses, including for example speech via speaker 134, gestures performed by the arms 106, 108, and/or facial expressions for the eyes and mouth on the display screens 72, 74 and 76.

For example, in embodiments, the robot 100 is configured for social interaction, or at least emulating social interaction, with one or more children or other individuals in the environment (vicinity) of the robot 100. Using data from microphones 158 and/or cameras 160, the computing device 126 is capable of identifying the presence and location of an individual in the vicinity of the robot. At that point, the computing device 126 may turn the torso 104 to face that individual, and position the head 110 so as to appear to be maintaining eye contact with the individual. The eyes may also be rendered on displays 74 and 76 with the pupils centered on the individual with which the robot is interacting, to further enhance the impression that the robot is focused on that individual.

In embodiments, the processor of the computing device may implement a neural network, such as for example a convolutional neural network or other artificial intelligence algorithms, for receiving all sensor data and determining an appropriate response. The neural network may be trained on a large data set to infer an appropriate response, or set of responses, to any given set of data received from all sensors in the robot 100. In embodiments where robot 100 is a social interaction robot, an appropriate response may be a response emulating a socially acceptable response to the input received by the computing device 126.

In embodiments, the computing device 126 may receive data from the microphones 158 and/or cameras 160 indicating an age, or age group, of an individual with which the robot is interacting. The neural network may train a response that is tailored to individuals of the perceived age or age group. Thus, the same input may illicit a different response from robot 100 when the computing device determines that the individual providing the input is a child as opposed to an adult.

As noted above, the robot may turn, and position the head and rendered eyes, so as to appear to be interacting with a particular individual, or focused on a particular object. Following are some additional examples of the robot's response to input and ability to interact with children or other individuals. The following is not intended as an exhaustive listing, and the robot 100 is capable of a wide variety of other or additional interactive capabilities.

Using the two degrees of freedom of arms 106 or 108, the robot may point at given locations, people and objects. The robot may be pointing at an object serving as a shared context between robot and individual, such as for example a book, or TV screen, so as to direct the individual's attention to these objects.

Using the rendered eyes and mouth, the robot may emulate expressing emotions, for example to empathize or sympathize with an individual with which the robot is interacting.

Using the microphones, speaker, and ASR and TTS algorithms in the computing device, the robot 100 may carry on a conversation with an individual with which the robot is interacting. As noted, the neural network of the computing device 126 may customize that conversation depending on age level of the participant(s) in the conversation. Where for example there are multiple children around the robot, the robot may, in turn, face the different children and carry on a discourse with each. Thus, the robot 100 may for example tell a story to children, and answer questions from different children listening to the story.

It is known to use ASR and TTS algorithms for different languages. Using again the microphones, speaker, and ASR and TTS algorithms in the computing device, the robot 100 may teach primary and foreign languages to children or adults interacting with the robot 100.

FIG. 11 is a block diagram of a network processing device 1101 that can be used to implement various embodiments of computing system 130 in accordance with the present technology. Specific network processing devices may utilize all of the components shown, or only a subset of the components, and levels of integration may vary from device to device. Furthermore, the network processing device 1101 may contain multiple instances of a component, such as multiple processing units, processors, memories, transmitters, receivers, etc. The network processing device 1101 may be equipped with one or more input/output devices, such as network interfaces, storage interfaces, and the like. The processing unit 1101 may include a central processing unit (CPU) 1110, graphics processing unit (GPU) 1115, a memory 1120, a mass storage device 1130, and an I/O interface 1160 connected to a bus 1170. The bus 1170 may be one or more of any type of several bus architectures including a memory bus or memory controller, a peripheral bus or the like.

The CPU 1110 may comprise any type of electronic data processor. The GPU 1115 may comprise any type of electronic graphics processor for rendering images on screen displays 72, 74 and 76. In embodiments, the GPU 1115 may be separate from the CPU 1110. In further embodiments, the GPU 1115 may be integrated as part of CPU 1110.

The memory 1120 may comprise any type of system memory such as static random access memory (SRAM), dynamic random access memory (DRAM), synchronous DRAM (SDRAM), read-only memory (ROM), a combination thereof, or the like. In an embodiment, the memory 1120 may include ROM for use at boot-up, and DRAM for program and data storage for use while executing programs. In embodiments, the memory 1120 is non-transitory. The mass storage device 1130 may comprise any type of storage device configured to store data, programs, and other information and to make the data, programs, and other information accessible via the bus 1170. The mass storage device 1130 may comprise, for example, one or more of a solid state drive, hard disk drive, a magnetic disk drive, an optical disk drive, or the like.

The processing unit 1101 may further include a variety of sensors 1140, including for example the microphone 158, cameras 160, the outer layer touch sensors, and/or RFID sensors. The sensors 1140 sense features of the environment around the robot 100 and provide the feedback to the CPU 1110. The processing unit 1101 may further include motor controllers for controlling the operation of the motors 128, 130, 138, 140, 144 and 154 under the direction of the CPU 1110. There may be a single motor controller 1150, or an individual motor controller for each motor. Various cables or wires may be run through the robot 100 to electrically couple the motors, speaker, sensors and display screens with the computing device 126. In a further embodiment, instead of being a single centralized computing device, the computing device may be distributed throughout the robot 100.

The processing unit 1101 also includes one or more network interfaces 1150, which may comprise wired links, such as an Ethernet cable or the like, and/or wireless links to access nodes or one or more networks 1180. The network interface 1150 allows the processing unit 1101 to communicate with remote units via the networks 1180. For example, the network interface 1150 may provide wireless communication via one or more transmitters/transmit antennas and one or more receivers/receive antennas. In an embodiment, the processing unit 1101 is coupled to a local-area network or a wide-area network for data processing and communications with remote devices, such as other processing units, the Internet, remote storage facilities, or the like.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A robot configured for social interaction with one or more individuals, the robot comprising:
a torso;
arms configured for movement relative to the torso;
a head configured for movement relative to the torso;
one or more sensors configured to sense an environment around the robot;
display screens in the head configured to display various images of eyes and a mouth of the robot;
a speaker; and
a processor for executing software instructions to:
receive feedback of the environment surrounding the robot from the one or more sensors;
interpret the feedback of the environment; and
perform an action responsive to the feedback of the environment as interpreted, wherein the action comprises displaying on one or more of the display screens one or more of the eyes and the mouth with an expression that emulates a human response to the feedback of the environment.

2. The robot of claim 1, wherein the action further comprises outputting an audio response over the speaker based on the feedback of the environment as interpreted to emulate the human response to the feedback of the environment.

3. The robot of claim 2, wherein the outputting comprises having a conversation with the one or more individuals.

4. The robot of claim 1, wherein the action further comprises performing a gesture with the arms based on the feedback of the environment as interpreted to emulate the human response to the feedback of the environment.

5. The robot of claim 1, wherein the processor is further configured to position the head in a direction of the one or more individuals.

6. The robot of claim 1, wherein the processor is implemented using a neural network that improves an ability of the processor to interpret the feedback of the environment over time.

7. The robot of claim 6, wherein the one or more sensors detect an age group of an individual of the one or more individuals, and wherein the neural network interprets the feedback based on the age group detected.

8. The robot of claim 1, wherein one or more of the arms and the head are configured to move with at least two degrees of freedom relative to the torso.

9. The robot of claim 1, further comprising a base, wherein the torso is configured to rotate relative to the base.

10. The robot of claim 1, wherein the one or more sensors comprise radio frequency identification (RFID) readers in the arms of the robot.

11. The robot of claim 1, wherein the one or more sensors comprise one or more of a camera for capturing images of the environment surrounding the robot, a microphone for capturing audio in the environment surrounding the robot, and touch sensors for sensing physical contact with the robot.

12. The robot of claim 11, wherein the touch sensors comprise a conductive layer applied to a surface of the robot to enable the sensing of the physical contact over an entirety of the surface.

13. A robot configured for social interaction, the robot comprising:
a torso;
arms configured for movement relative to the torso;
a head configured for movement relative to the torso;
one or more sensors configured to sense a child actions with the robot;
display screens in the head configured as eyes and a mouth of the robot; and
a processor configured to implement a neural network for executing software instructions to:
receive feedback of the child's actions from the one or more sensors;
interpret the feedback of the child's actions;
formulate a response of the robot based on the child's actions as interpreted by the processor; and
implement the response by one or more of positioning the arms, positioning the head, and displaying a facial expression using one or more of the eyes and the mouth on the display screens.

14. The robot of claim 13, further comprising motors for moving the arms and the head, wherein the motors are controlled by the processor.

15. The robot of claim 13, wherein the response from the robot comprises displaying one or more of the eyes and the mouth on one or more of the display screens with an appearance emulating the facial expression responsive to the child's actions.

16. The robot of claim 13, wherein the response from the robot is to move one or more of the head, the arms, and the torso emulating a human response to the child's actions.

17. The robot of claim 13, further comprising a speaker, wherein the response from the robot is to provide an audio response to the child's actions over the speaker.

18. A robot configured for social interaction, the robot comprising:
a torso;
arms configured for movement relative to the torso;
a head configured for movement relative to the torso;
one or more sensors configured to sense an environment around the robot;
display screens in the head configured as eyes and a mouth of the robot; and
a processor implementing a neural network, the processor configured to:
receive feedback of the environment surrounding the robot from the one or more sensors, the feedback including detecting an age group of an individual around the robot;
determine a response of the robot to the feedback based on training of the neural network and a detected age group of the individual;
providing the response that was determined to facilitate a social interaction of the robot, wherein the response comprises rendering one or more of eyes and the mouth on one or more of the display screens and positioning one or more of the torso, the arms, and the head.

19. The robot of claim 18, wherein the one or more sensors comprise one or more of a camera, a microphone, and a tactile sensor.

20. The robot of claim 18, wherein the positioning comprises moving the torso and the head of the robot to face the individual, and wherein the processor is further configured to render pupils in the eyes to look at the individual.
